(19) United States
(12) Patent Application Publication
(10) Pub. No.: US 2014/0022903 A1
(43) Pub. Date: Jan. 23, 2014

(54) PACKET SWITCH, TRANSMISSION DEVICE, AND PACKET TRANSMISSION METHOD

(71) Applicant: FUJITSU LIMITED, Kawasaki-shi (JP)

(72) Inventors: Akio SHINOHARA, Tochigi (JP); Satoshi Nemoto, Oyama (JP); Shigetoshi Nakai, Kuki (JP)

(21) Appl. No.: 13/893,779

(22) Filed: May 14, 2013

(30) Foreign Application Priority Data
Jul. 23, 2012 (JP) 2012-162576

(51) Int. Cl. H04L 12/803

(52) U.S. Cl. CPC H04L 47/122
USPC 370/235

(57) ABSTRACT

A packet switch includes an ingress unit configured to divide packet data into a plurality of segments, and allocate each of segments to any one of a plurality of links, a switching fabric unit configured to include a plurality of switches, each of switches switching the segments to the links in accordance with destinations of the segments, respectively, and an egress unit configured to receive the segments, and reconstruct the segments in the packet data, wherein the ingress unit transmits the segments to the links on which no back pressure signal is transferred and another link on which the back pressure signal is transferred and on which the segment have not been transmitted in specific period, based on a back pressure signal supplied from each of switches and a transmission flag indicating whether or not the segment have been transmitted to the links.

### CROSS-REFERENCE TO RELATED APPLICATION

This application is based upon and claims the benefit of priority of the prior Japanese Patent Application No. 2012-162576, filed on Jul. 23, 2012, the entire contents of which are incorporated herein by reference.

### FIELD

The embodiment discussed herein is related to a packet switch, a transmission device, and a packet transmission method.

### BACKGROUND

FIG. 1 illustrates a configuration of an example of a packet switch in a transmission device. The transmission device includes ingress units 1-1 to 1-16, a switching fabric (SWF) unit 2, and egress units 3-1 to 3-16.

Each of the ingress units 1-1 to 1-16 includes an ingress buffer 1a that buffers a packet that has been input, a load sharing unit 1b that divides the packet read from the ingress buffer 1a into segments and adds sequential numbers to the segments, and transmits the segments to, for example, 16 systems of links so as to perform load sharing, and first-in-first-outs (FIFOs) 1c-1 to 1c-16 coupled to the 16 systems of links respectively.

The SWF unit 2 includes 16 switches 2-1 to 2-16 that correspond to the 16 systems of links respectively, and each of the switches 2-1 to 2-16 switches segment data in accordance with destinations of the segment data and supplies the segment data to the egress units 3-1 to 3-16.

Each of the egress units 3-1 to 3-16 includes an egress buffer 3a that buffers the segment data supplied from the SWF unit 2, and a packet reconstruction buffer 3b that reads the segment data stored in the egress buffer 3a in the sequence order, reconstructs the packet, and buffers the reconstructed packet.

Typically, the transmission device controls a round robin algorithm of the load sharing unit 1b in each of the ingress units 1-1 to 1-16 using a back pressure detection signal BP for each link from the SWF unit 2. That is, the load sharing unit 1b performs control to suppress congestion or retention in the switches 2-1 to 2-16 of the SWF unit 2 by stopping transmission of the segment data from the ingress unit to a link for which back pressure is detected in the SWF unit 2.

In each of the egress units 3-1 to 3-16, the egress buffer 3a temporarily buffers the segment data output from each of the switches 2-1 to 2-16 of the SWF unit 2. The segment data in the egress buffer 3a are affected by the transmission stoppage of the ingress units 1-1 to 1-16 caused by the above-mentioned back pressure, the output of the segment data from the plurality of ingress units, or an output algorithm of the switches 2-1 to 2-16. Thus, the segment data in the egress buffer 3a include an order reversal or a phase delay when regarded as packet data. The segment data from the egress buffer 3a are rearranged by the packet reconstruction buffer 3b to be desirable packet data.

See, for example, Japanese Laid-Open Patent Publication No. 2008-236304 and Japanese Laid-Open Patent Publication No. 2011-49966.

### SUMMARY

According to an aspect of the invention, a packet switch includes an ingress unit configured to divide packet data into a plurality of segments, and allocate each of the plurality of segments to any one of a plurality of links, a switching fabric unit configured to include a plurality of switches, each of the plurality of switches switching the segments from the ingress unit to the plurality of links in accordance with destinations of the segments, respectively, and an egress unit configured to receive the segments from the plurality of switches, reconstruct the received segments in the packet data, and transmit the reconstructed packet data, wherein the ingress unit transmits the segments to the links on which no back pressure signal is transferred and another link on which the back pressure signal is transferred and on which the segment have not been transmitted in specific period, based on a back pressure signal supplied from each of the plurality of switches and a transmission flag indicating whether or not the segment have been transmitted to the plurality of links.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of an example of a packet switch;

FIG. 2 is a chart illustrating a typical RR algorithm;

FIG. 3 is a diagram illustrating a configuration of a packet switch according to an embodiment;

FIG. 4 is a chart illustrating RR algorithms according to the embodiment;

FIG. 5 is a flowchart illustrating a load sharing process performed by a load sharing unit;

FIGS. 6A, 6B, 6C, and 6D are diagrams for explaining operations of the load sharing process;

FIGS. 7A, 7B, 7C, and 7D are diagrams for explaining the operations of the load sharing process;

FIGS. 8A, 8B, 8C, and 8D are diagrams for explaining the operations of the load sharing process;

FIGS. 9A, 9B, 9C, and 9D are diagrams for explaining the operations of the load sharing process;

FIGS. 10A, 10B, 10C, and 10D are diagrams for explaining the operations of the load sharing process;

FIGS. 11A and 11B are charts illustrating simulation results; and

FIG. 12 is a bar graph illustrating the simulation results in FIGS. 11A and 11B.

### DESCRIPTION OF EMBODIMENTS

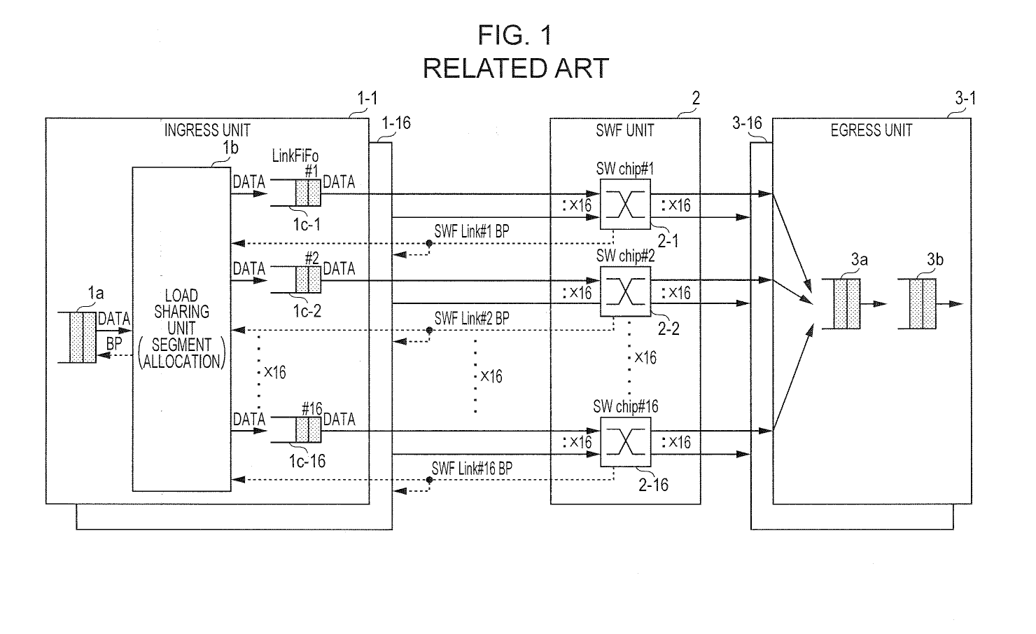

As described in relation to FIG. 1, the ingress units 1-1 to 1-16 equally transmit the segment data to the respective switches 2-1 to 2-16 in the SWF unit 2 via the links. However, since the ingress units 1-1 to 1-16 do not cooperate with one another, the amounts of the segment data vary among the switches 2-1 to 2-16 when regarded on the whole. As a result, the numbers of times back pressure is applied from the switches 2-1 to 2-16 of the SWF unit 2 vary as well.

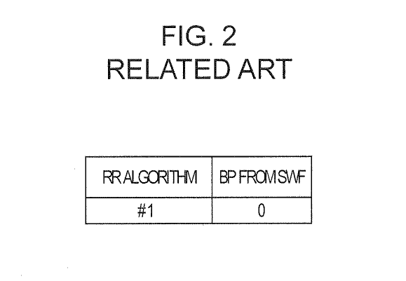

FIG. 2 illustrates a typical round robin algorithm. There is one type of typical round robin (RR) algorithm, which is “#1”, and when a value of the back pressure detection signal BP is 0 and no back pressure is detected, the load sharing unit 1b supplies the segment data to the switch where the value of the back pressure detection signal BP is 0. When the value of the back pressure detection signal BP is 1 and back pressure is detected, the load sharing unit 1b stops supplying the segment data to the switch that has output the back pressure detection signal BP of value 1.

Thus, when back pressure is applied, each of the ingress units 1-1 to 1-16 stops transmitting the segment data to the switch that has applied the back pressure in accordance with the typical RR algorithm, and the stoppage causes another variation among the switches.

As a result, the deviation of a throughput delay increases, which depends on time taken for the segment data obtained by dividing some packet data in the ingress units 1-1 to 1-16 to pass through the switches 2-1 to 2-16 in the SWF unit 2, and as the case may be, the packet data may fail to be reconstructed from the segment data received by the egress units 3-1 to 3-16.

An embodiment of the packet switch for decreasing a deviation of time taken for segment data to pass through a plurality of switches is described below with reference to the drawings.

### [Configuration of Packet Switch]

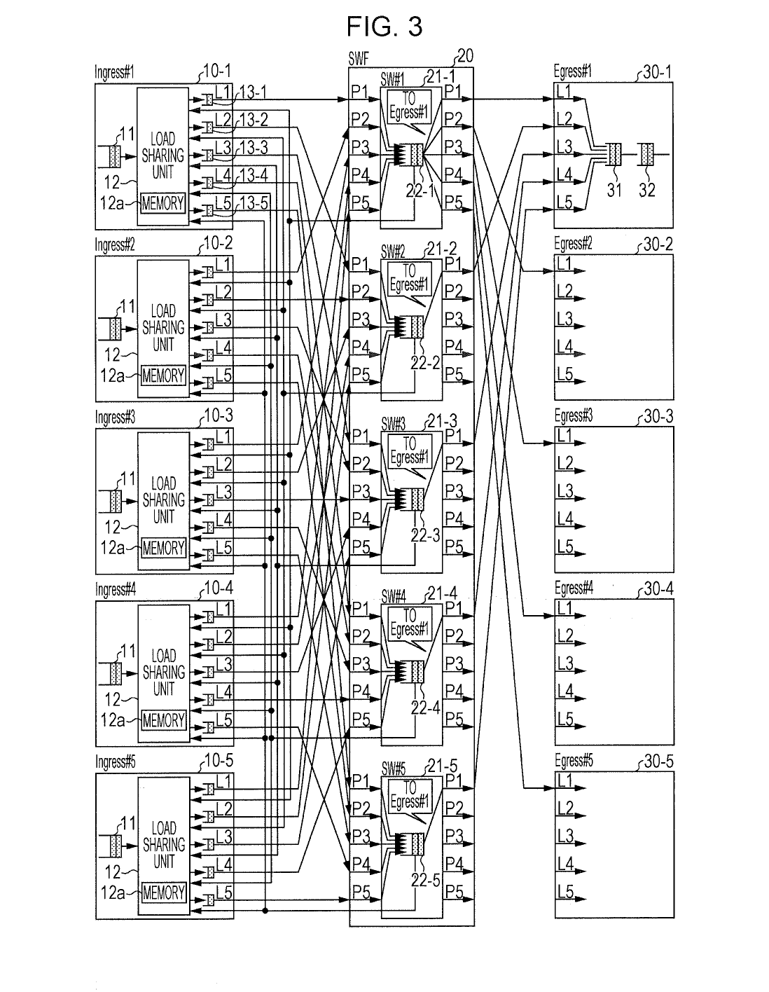

FIG. 3 illustrates a configuration of a packet switch in a transmission device according to the embodiment. The transmission device includes ingress units 10-1 to 10-5, a switching fabric (SWF) unit 20, which includes switches 21-1 to 21-5, and egress units 30-1 to 30-5. Although part of the present embodiment discusses the ingress units 10-1 to 10-5, the switches 21-1 to 21-5, the egress units 30-1 to 30-5, and the links L1 to L5 as five systems each, the actual numbers of systems of the ingress units, the switches, the egress units, and the links are all 16 and are not limited to five or 16, that is, may be another, such as 32. For example, the ingress units 10-1 to 10-5 and the egress units 30-1 to 30-5 are made up of five boards and the SWF unit 20 is made up of one board.

Each of the ingress units 10-1 to 10-5 includes an ingress buffer 11 that buffers a packet that has been input, a load sharing unit 12 that divides the packet read from the ingress buffer 11 into segments and adds sequential numbers to the segments, and transmits the segments to the five systems of links L1 to L5 so as to perform load sharing, and first-in-first-outs (FIFOs) 13-1 to 13-5 that buffer the segment data from the load sharing unit 12 and are coupled to the five systems of links L1 to L5 respectively. For example, the ingress buffer 11 is made up of a FIFO. For example, the ingress units 10-1 to 10-5 are made up of electronic circuits including a field programmable gate array (FPGA).

The SWF unit 20 includes the five switches 21-1 to 21-5 corresponding to the five systems of links L1 to L5 respectively, and the switches 21-1 to 21-5 include buffers 22-1 to 22-5 respectively. The switches 21-1 to 21-5 include ports P1-P5 of a side of the ingress units 10-1 to 10-5 respectively, and port P1-P5 of a side of the egress units 30-1 to 30-5 respectively. Each of the switches 21-1 to 21-5 switches segment data in accordance with destinations of the segment data and performs destination allocation for supplying the segment data to the egress units 30-1 to 30-5 via the buffers 22-1 to 22-5. For example, each of the buffers 22-1 to 22-5 is made up of a FIFO and supplies a back pressure detection signal BP indicating value 1 to the load sharing unit 12 in each of the ingress units 10-1 to 10-5 when packets are accumulated beyond, for example, 80 to 90 percent of the capacity. For example, the SWF unit 20 is made up of an electronic circuit including an FPGA.

The egress units 30-1 to 30-5 are supplied with the segment data corresponding to the links L1 to L5 from the switches 21-1 to 21-5 in the SWF unit 20. Each of the egress units 30-1 to 30-5 includes an egress buffer 31 that temporarily buffers the supplied segment data, and a packet reconstruction buffer 32 that arranges the segment data stored in the egress buffer 31 in the sequence order to reconstruct and buffer the packet. The packet reconstruction buffer 32 outputs the reconstructed packet. For example, the egress buffer 31 is made up of a FIFO. For example, the egress units 30-1 to 30-5 are made up of electronic circuits including an FPGA.

In addition to the packet switch depicted in FIG. 3, the transmission device includes, for example, a format conversion unit that converts the packet supplied from a network to a packet of an internal format for performing switching in the packet switch, and a format reverse-conversion unit that reversely converts the packet of the internal format, which has been switched by the packet switch, into a format of the network and transmits the packet to the network.

### [Round Robin Algorithms]

In the present embodiment, the load sharing unit 12 in each of the ingress units 10-1 to 10-5 sets a transmission flag for each of the five links L1 to L5. The transmission flag is held in memory 12a in the load sharing unit 12 along with the back pressure detection signal BP. An initial value of the transmission flag is 0, and the value of the transmission flag is incremented by one when the segment data are transmitted to each link. When the values of the transmission flags for all links are 1 or more, each of the values of the transmission flags for all links is decremented by one.

The back pressure detection signal BP is supplied from the switches 21-1 to 21-5 corresponding to the links L1 to L5 respectively, and for example, indicates value 0 when no back pressure is detected or indicates value 1 when back pressure is detected.

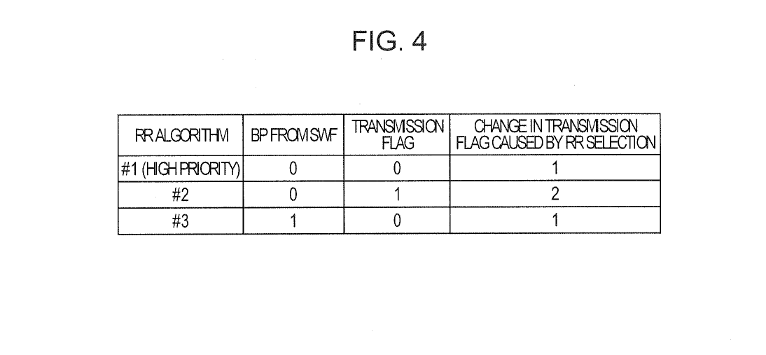

FIG. 4 illustrates RR algorithms according to the present embodiment. The present embodiment discusses three types of RR algorithms, which are “#1”, “#2”, and “#3” corresponding to combinations of the values of the back pressure detection signal BP and the transmission flag. The lower the number of the RR algorithm is, the higher the priority of the RR algorithm is, that is, the RR algorithm #1 has the highest priority. The RR algorithms #1 to #3 are selected for each of the links L#1 to L#5.

When no back pressure is detected for the link L#i, where i is an integer from 1 to 5, and the value of the back pressure detection signal BP is 0 while the value of the transmission flag is 0, the load sharing unit 12 selects the RR algorithm #1 and outputs the segment data to the link L#i. When the value of the back pressure detection signal BP is 0 and the value of the transmission flag is 1, the load sharing unit 12 selects the RR algorithm #2 and outputs the segment data to the link L#i. When the value of the back pressure detection signal BP is 1 and the value of the transmission flag is 0, the load sharing unit 12 selects the RR algorithm #3 and outputs the segment data to the link L#i. Each number listed in the column “CHANGE IN TRANSMISSION FLAG CAUSED BY RR SELECTION” in the chart of FIG. 4 indicates the value of the transmission flag, which changes after the segment data have been transmitted.

When, with respect to each of the links L#1 to L#5, the value of the back pressure detection signal BP is 1 and the value of the transmission flag is 1, or 1 or more, the load sharing unit 12 stops outputting the segment data to the link.

### [Flowchart of Load Sharing Process]

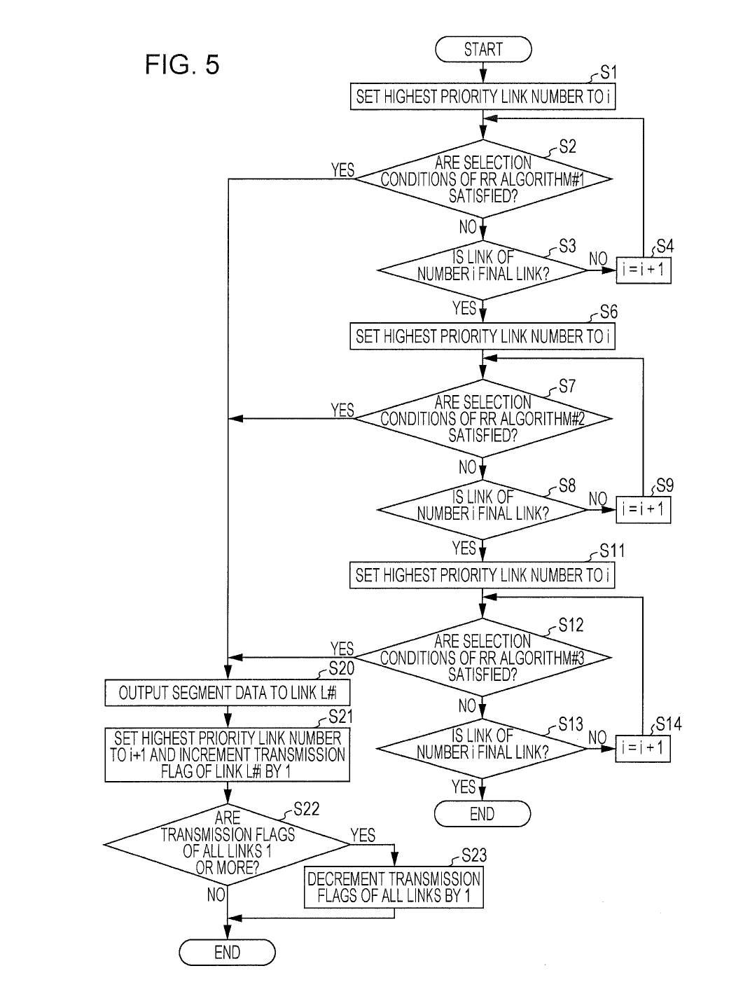

FIG. 5 is a flowchart illustrating a load sharing process performed by the load sharing unit 12. A link number i is an integer from 1 to 5, and the present embodiment employs a ring configuration in which when i=5 and i is incremented by one, then i=1. A link of a number that is smaller than a highest priority link number by one is referred to as a final link. The highest priority link number equals a number that indicates a link on which the load sharing process is performed with the highest priority.

In operation S1 in FIG. 5, the value of the highest priority link number is set to the link number i. After that, it is judged in operation S2 whether or not selection conditions of the RR algorithm #1 are satisfied for the link of the link number i. The selection conditions of the RR algorithm #1 are, with respect to the link, that the value of the back pressure detection signal BP is 0 and that the value of the transmission flag is 0. When the selection conditions of the RR algorithm #1 are satisfied, the process proceeds to operation S20. When the selection conditions of the RR algorithm #1 are not satisfied, it is judged in operation S3 whether or not the link of the link number i is the final link. When the link of the link number i is not the final link, the link number i is incremented by one in operation S4 and the process returns to operation S2. When the link of the link number i is the final link, the process proceeds to operation S6.

In operation S6, the value of the highest priority link number is set to the link number i. After that, it is judged in operation S7 whether or not selection conditions of the RR algorithm #2 are satisfied for the link of the link number i. The selection conditions of the RR algorithm #2 are, with respect to the link, that the value of the back pressure detection signal BP is 0 and that the value of the transmission flag of the link is 1. When the selection conditions of the RR algorithm #2 are satisfied, the process proceeds to operation S20. When the selection conditions of the RR algorithm #2 are not satisfied, it is judged in operation S8 whether or not the link of the link number i is the final link. When the link of the link number i is not the final link, the link number i is incremented by one in operation S9 and the process returns to operation S7. When the link of the link number i is the final link, the process proceeds to operation S11.

In operation S11, the value of the highest priority link number is set to the link number i. After that, it is judged in operation 512 whether or not selection conditions of the RR algorithm #3 are satisfied for the link of the link number i. The selection conditions of the RR algorithm #3 are, with respect to the link, that the value of the back pressure detection signal BP is 1 and that the value of the transmission flag of the link is 0. When the selection conditions of the RR algorithm #3 are satisfied, the process proceeds to operation S20. When the selection conditions of the RR algorithm #3 are not satisfied, it is judged in operation S13 whether or not the link of the link number i is the final link. When the link of the link number i is not the final link, the link number i is incremented by one in operation S14 and the process returns to operation S12. When the link of the link number i is the final link, the process ends.

In operation S20, in accordance with the RR algorithm #1, #2, or #3 for which the selection conditions are satisfied in operation S2, S7, or S12, the segment data are transmitted to the link of the link number i. After that, in operation S21, the value of i+1 is set as the highest priority link number and the value of the transmission flag corresponding to the link number i is incremented by one.

After that, it is judged in operation S22 whether or not the values of the transmission flags of all the links L#1 to L#5 are 1 or more. When the values of the transmission flags of all the links L#1 to L#5 are 1 or more, the values of the transmission flags of all the links L#1 to L#5 are decremented by one in operation S23 and the process ends. When the values of the transmission flags of all the links L#1 to L#5 are not 1 or more, the process ends without any values being changed.

### [Operations]

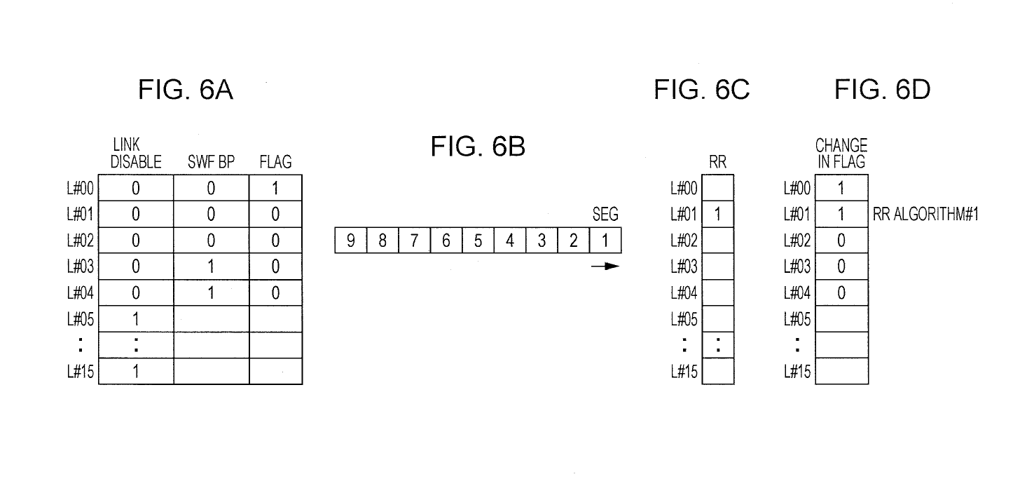

The operations of the load sharing process are described with reference to FIGS. 6A to 10D, where the numbers of systems of ingress units, switches in the switching fabric unit, egress units, and links are all 16. For convenience of explanation, among the 16 systems of links L#00 to L#15, the links L#00 to L#04 for which value 0 is indicated in the column “LINK DISABLE” are activated while the links L#05 to L#15 for which value 1 is indicated in the column “LINK DISABLE” are inactivated. Initially, the highest priority link is the link L#01.

As illustrated in FIG. 6A, the value of the back pressure detection signal (“SWF BP”) is 0 for the links L#00 to L#02 and is 1 for the links L#03 and L#04, and the value of the transmission flag (“FLAG”) is 1 for the link L#00 and is 0 for the links L#01 to L#04. In this state, the load sharing unit 12 decides a destination of segment data (“SEG”) 1 of the packet illustrated in FIG. 6B based on the link L#01 set as the highest priority link. In this case, with respect to the highest priority link L#01, the value of the back pressure detection signal is 0 and the value of the transmission flag is 0. Thus, the load sharing unit 12 selects the RR algorithm (“RR”) #1 and outputs the segment data 1 from the link L#01 as illustrated in FIG. 6C. As a result, as illustrated in FIG. 6D, the values of the transmission flags for the links L#00 and L#01 are 1 and are 0 for the links L#03 and L#04, and the highest priority link is the link L#02.

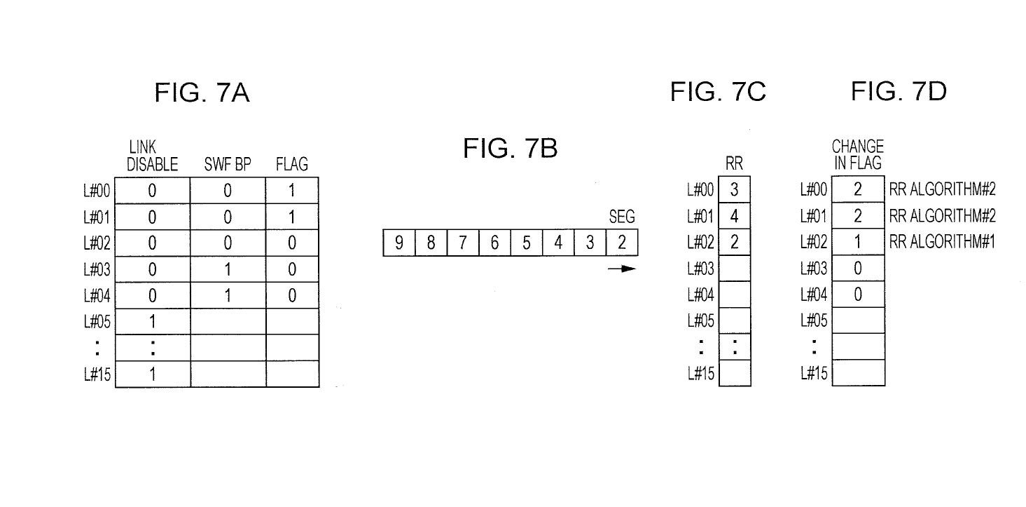

The state in which the link L#02 is set as the highest priority link is illustrated in FIG. 7A. In this state, the load sharing unit 12 decides a destination of segment data 2 of the packet illustrated in FIG. 7B based on the link L#02. In this case, with respect to the highest priority link L#02, the value of the back pressure detection signal is 0 and the value of the transmission flag is 0, and the selection conditions of the RR algorithm #1 are satisfied. Thus, the load sharing unit 12 outputs the segment data 2 from the link L#02 in accordance with the RR algorithm #1 as illustrated in FIG. 7C. As a result, the value of the transmission flag for the link L#02 is 1 and the highest priority link is the link L#03.

After that, the load sharing unit 12 decides a destination of segment data 3 of the packet illustrated in FIG. 7B based on the link L#03. In this case, since the value of the transmission flag for the link L#03 is 1, the selection conditions of the RR algorithm #1 are not satisfied. However, with respect to the link L#00, the value of the back pressure detection signal is 0 and the value of the transmission flag is 1, and the selection conditions of the RR algorithm #2 are satisfied. Thus, the load sharing unit 12 outputs the segment data 3 from the link L#00 in accordance with the RR algorithm #2 as illustrated in FIG. 7C. As a result, the value of the transmission flag for the link L#00 is 2 and the highest priority link is the link L#01.

After that, the load sharing unit 12 decides a destination of segment data 4 of the packet illustrated in FIG. 7B based on the link L#01 set as the highest priority link. In this case, since the value of the transmission flag is 1, the selection conditions of the RR algorithm #1 are not satisfied. However, with respect to the highest priority link L#01, the value of the back pressure detection signal is 0 and the value of the transmission flag is 1, and the selection conditions of the RR algorithm #2 are satisfied. Thus, the load sharing unit 12 outputs the segment data 4 from the link L#01 in accordance with the RR algorithm #2 as illustrated in FIG. 7C. As a result, as illustrated in 7D, the value of the transmission flag for the link L#01 is 2 and the highest priority link is the link L#02.

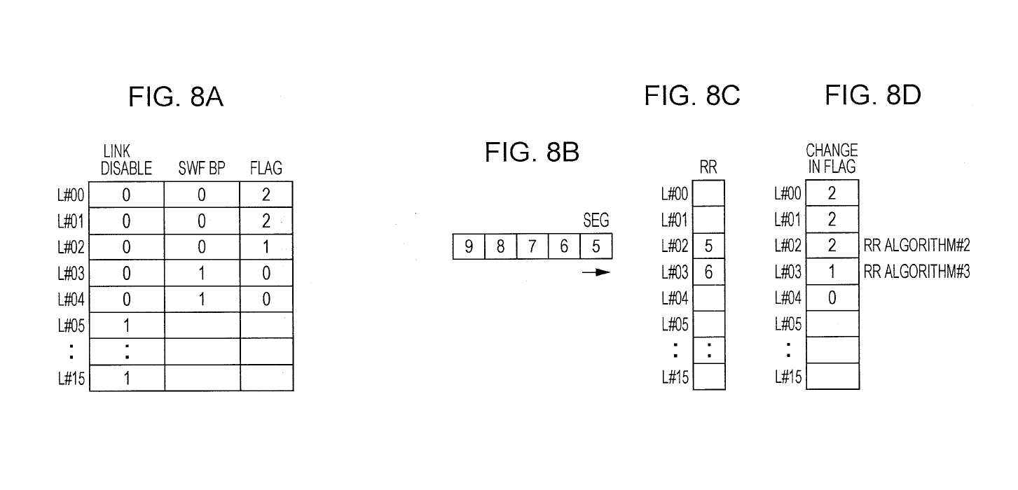

The state in which the link L#02 is set as the highest priority link is illustrated in FIG. 8A. In this state, the load sharing unit 12 decides a destination of segment data 5 of the packet illustrated in FIG. 8B based on the link L#02. In this case, since the value of the transmission flag is 1, the selection conditions of the RR algorithm #1 are not satisfied. However, with respect to the highest priority link L#02, the value of the back pressure detection signal is 0 and the value of the transmission flag is 1, and the selection conditions of the RR algorithm #2 are satisfied. Thus, the load sharing unit 12 outputs the segment data 5 from the link L#02 in accordance with the RR algorithm #2 as illustrated in FIG. 8C. As a result, the value of the transmission flag for the link L#02 is 2 and the highest priority link is the link L#03.

After that, the load sharing unit 12 decides a destination of segment data 6 of the packet illustrated in FIG. 8B based on the link L#03 set as the highest priority link. In this case, since the value of the back pressure detection signal is 1, the selection conditions of the RR algorithms #1 and #2 are not satisfied. However, with respect to the highest priority link L#03, the value of the back pressure detection signal is 1 and the value of the transmission flag is 0, and the selection conditions of the RR algorithm #3 are satisfied. Thus, the load sharing unit 12 outputs the segment data 6 from the link L#03 in accordance with the RR algorithm #3 as illustrated in FIG. 8C. As a result, as illustrated in 8D, the value of the transmission flag for the link L#03 is 1 and the highest priority link is the link L#04.

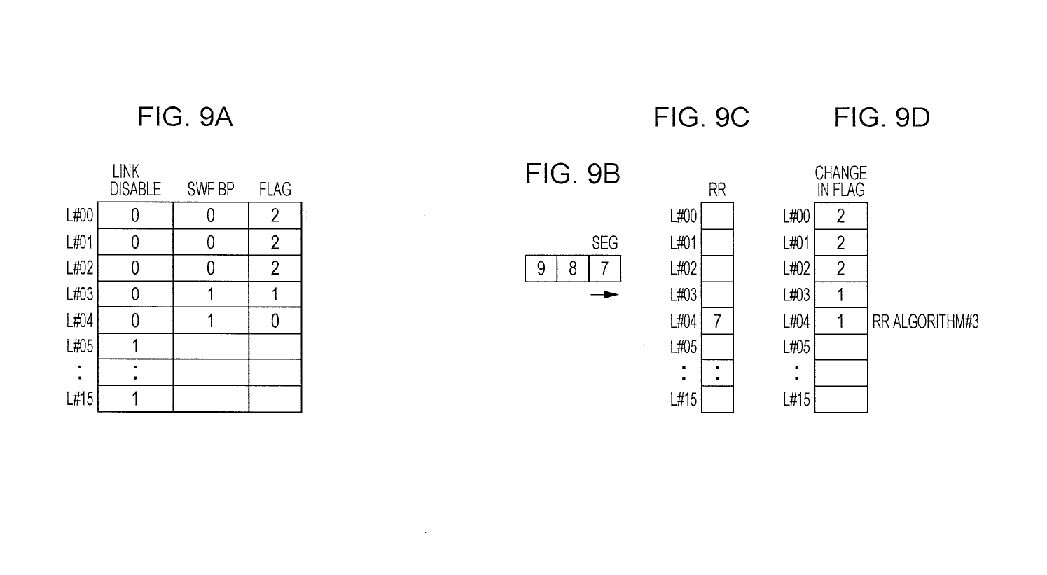

The state in which the link L#04 is set as the highest priority link is illustrated in FIG. 9A. In this state, the load sharing unit 12 decides a destination of segment data 7 of the packet illustrated in FIG. 9B based on the link L#04. In this case, since the value of the back pressure detection signal is 1, the selection conditions of the RR algorithms #1 and #2 are not satisfied. However, with respect to the highest priority link L#04, the value of the back pressure detection signal is 1 and the value of the transmission flag is 0, and the selection conditions of the RR algorithm #3 are satisfied. Thus, the load sharing unit 12 outputs the segment data 7 from the link L#04 in accordance with the RR algorithm #3 as illustrated in FIG. 9C. As a result, as illustrated in FIG. 9D, the value of the transmission flag for the link L#04 is 1 and the highest priority link is the link L#00. Since the values of the transmission flags of all the links L#00 to L#04 are 1 or more in FIG. 9D, the values of the transmission flags of all the links L#00 to L#04 are decremented by one.

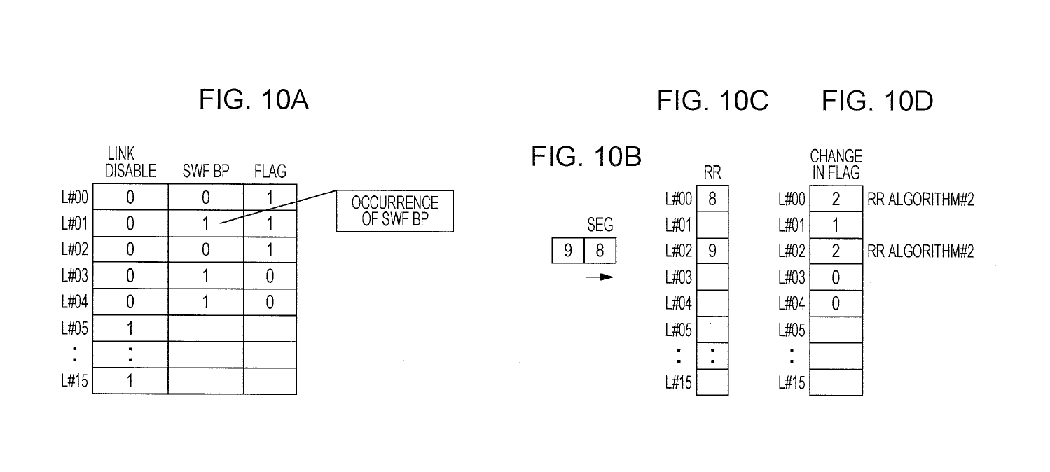

The state in which the values of the transmission flags of the links L#00 to L#04 are decremented is illustrated in FIG. 10A, and the back pressure detection signal indicating value 1 is occurring with respect to the link L#01. In this state, the load sharing unit 12 decides a destination of segment data 8 of the packet illustrated in FIG. 10B based on the link L#00. In this case, since the value of the transmission flag is 1, the selection conditions of the RR algorithm #1 are not satisfied. However, with respect to the highest priority link L#00, the value of the back pressure detection signal is 0 and the value of the transmission flag is 1, and the selection conditions of the RR algorithm #2 are satisfied. Thus, the load sharing unit 12 outputs the segment data 8 from the link L#00 in accordance with the RR algorithm #2 as illustrated in FIG. 10C. As a result, the value of the transmission flag for the link L#00 is 2 and the highest priority link is the link L#01.

After that, the load sharing unit 12 decides a destination of segment data 9 of the packet illustrated in FIG. 10B based on the link L#01. In this case, since the value of the back pressure detection signal is 1 and the value of the transmission flag is 1, the selection conditions of the RR algorithm #1 are not satisfied. However, with respect to the link L#02, the value of the back pressure detection signal is 0 and the value of the transmission flag is 1, and the selection conditions of the RR algorithm #2 are satisfied. Thus, the load sharing unit 12 outputs the segment data 9 from the link L#02 in accordance with the RR algorithm #2 as illustrated in FIG. 10C. As a result, as illustrated in FIG. 10D, the value of the transmission flag for the link L#02 is 2 and the highest priority link is the link L#03.

### [Simulation Results]

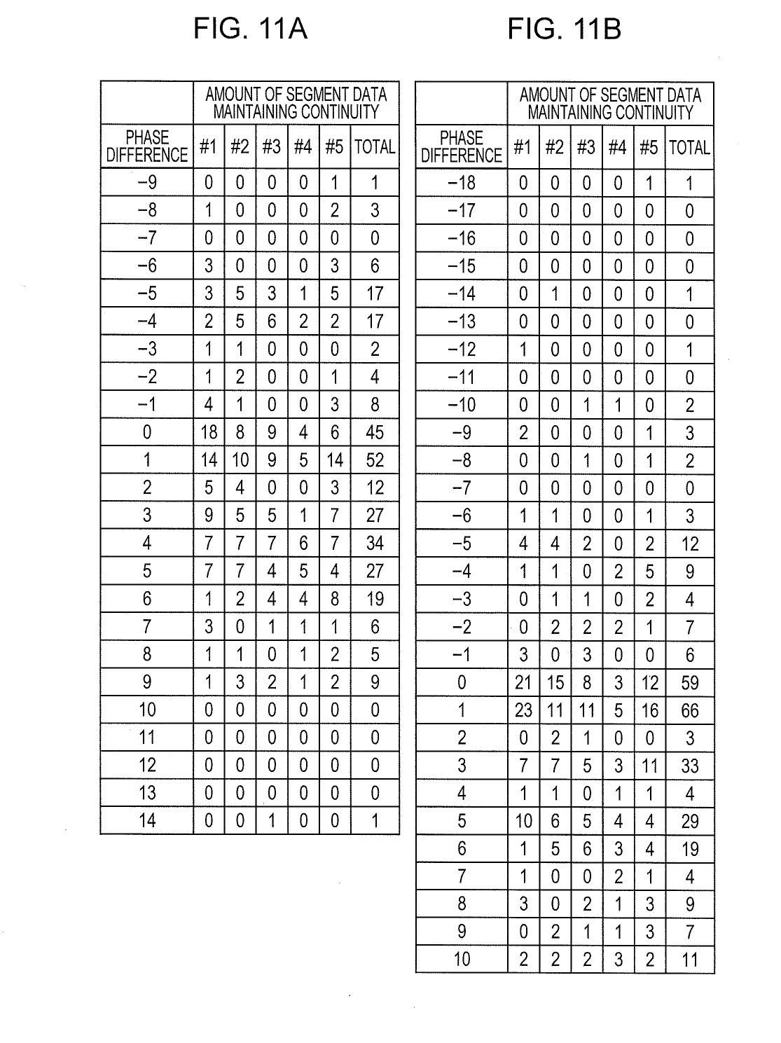

FIG. 11A illustrates simulation results obtained when the RR algorithms #1 to #3 in FIG. 4 according to the present embodiment are used. The column “PHASE DIFFERENCE” in FIG. 11A indicates phase differences on a clock basis. The values indicated in the column “#1” are described hereinafter. The segment data to which sequential numbers are added in the ingress unit 10-1 in FIG. 3 are allocated to the links L1 to L5 and output from the switches 21-1 to 21-5 in the SWF unit 20. When the segment data of a number n and a number n+1, which are sequential, are output from adjacent switches included in the switches 21-1 to 21-5 at substantially the same clock timing, counting of the phase difference 0 is performed so that the count is incremented by one.

When the segment data of the number n and the number n+1, which are sequential, are output from adjacent switches at timings different by i clock, where i is a positive or negative integer, which is from −9 to 14 in FIG. 11A for example, counting of a phase difference i is performed so that the count is incremented by one. Thus, the phase difference between adjacent segment data output from the ingress unit 10-1 is determined, and the column “#1” indicates how many times the phase difference i occurs. Similarly, the phase difference between adjacent segment data output from each of the ingress units 10-2 to 10-5 is determined, and the columns “#2” to “#5” indicate how many times the phase difference i occurs, respectively.

That is, the columns “#1” to “#5” indicate the amounts of segment data maintaining continuity in the switches 21-1 to 21-5, respectively. The column “TOTAL” indicates the total values of the amounts of the segment data maintaining continuity, which are indicated in the columns “#1” to “#5”. For comparison, FIG. 11B illustrates simulation results obtained when the RR algorithm in FIG. 2 is used.

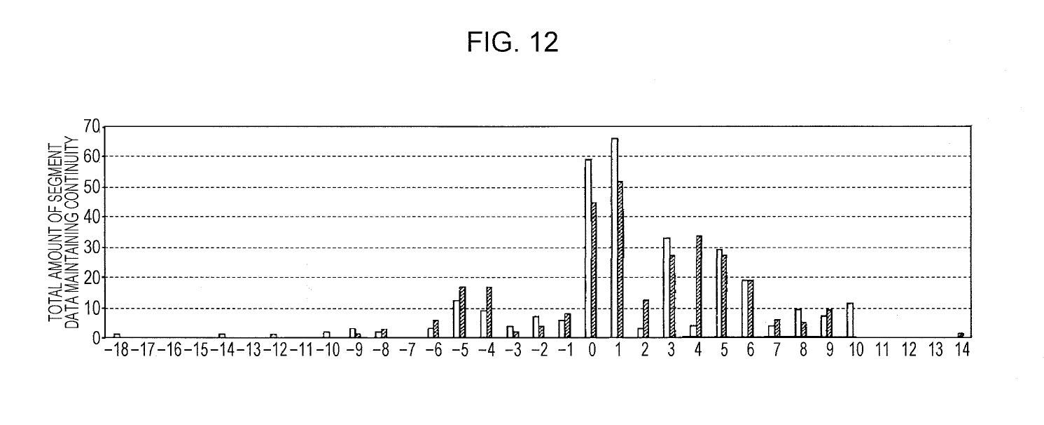

FIG. 12 is a bar graph illustrating the simulation results in FIGS. 11A and 11B. In FIG. 12, the values of the phase difference are indicated along the horizontal axis, and the length of each hatched bar represents the total value of the amounts of the segment data maintaining continuity in FIG. 11A, and the length of each blank bar represents the total value of the amounts of the segment data maintaining continuity in FIG. 11B. As illustrated in FIG. 12, when the continuity of the segment data output from the ingress units 10-1 to 10-5 is checked after the segment data have passed through the SWF unit 20, it is found that by using the RR algorithms in FIG. 4 according to the present embodiment, the total values of the amounts of the segment data maintaining continuity may be centered around the phase differences near 0 and the phase delay difference of the packet data to be reconstructed may converge or decrease more desirably.

In addition, using the RR algorithms in FIG. 4 according to the present embodiment instead of the RR algorithm in FIG. 2 may more desirably equalize the occurrences of the back pressure with respect to the ingress units 10-1 to 10-5 and suppress the deviation of the phase delay of the segment data that are preferably transmitted with continuity to the egress units 30-1 to 30-5. Accordingly, the buffer size of the packet reconstruction buffer 32 in each of the egress units 30-1 to 30-5 may be reduced while suppressing the throughput delay of the transmission device.

In the present embodiment, when no back pressure is occurring, equalized allocation of the data to be transmitted for the links is attempted by raising the priority when the value of the transmission flag is 0 and no segment data have been transmitted immediately previously and by lowering the priority when the value of the transmission flag is 1 and the segment data have been transmitted immediately previously. When the value of the transmission flag is 0 and no segment data have been transmitted immediately previously although back pressure has occurred, the equalized allocation of the data to be transmitted for the links is attempted by allowing the segment data to be transmitted to the link with a low priority and decreasing the frequency of the transmission stops of the segment data.

Thus, the deviation of the throughput delay dependent on time taken to pass through the switches 21-1 to 21-5 in the SWF unit 20 may be reduced. As a result, the phase delays of the segment data received at the egress units 30-1 to 30-5 may be reduced and for example, the possibility of a failure in the reconstruction of the packet data may be decreased.

The back pressure applied from the switches 21-1 to 21-5 in the SWF unit 20 determines the threshold value for the back pressure detection so that the buffers 22-1 to 22-5 may not overflow. According to the present embodiment, since the segment data may be transmitted also when back pressure has occurred, the threshold value for the back pressure detection is changed to be lower than a typical threshold value by, for example, approximately several percent to several tens of percent so as to suppress the overflow of the buffer in the switch.

Thus, the load sharing unit 12 in each of the ingress units 10-1 to 10-5 may suppress the overflow of the buffer in the switch without stopping transmission of the segment data to the switch even when the load sharing unit 12 receives the back pressure from the switch.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A packet switch comprising:
an ingress unit configured to divide packet data into a plurality of segments, and allocate each of the plurality of segments to any one of a plurality of links;
a switching fabric unit configured to include a plurality of switches, each of the plurality of switches switching the segments from the ingress unit to the plurality of links in accordance with destinations of the segments, respectively; and
an egress unit configured to receive the segments from the plurality of switches, reconstruct the received segments in the packet data, and transmit the reconstructed packet data,
wherein the ingress unit transmits the segments to the links on which no back pressure signal is transferred and another link on which the back pressure signal is transferred and on which the segment have not been transmitted in specific period, based on a back pressure signal supplied from each of the plurality of switches and a transmission flag indicating whether or not the segment have been transmitted to the plurality of links.

2. The packet switch according to claim 1,
wherein the ingress unit has a first algorithm including processes for selecting a link on which no back pressure signal is transferred and on which the segment have not been transmitted in the specific period and causing the segment to be transmitted to the selected link, and the second algorithm including processes for selecting another link on which no back pressure signal is transferred and on which the segment have been transmitted in the specific period and causing the segment to be transmitted,
wherein the ingress unit sets a priority of the first algorithm higher than the second algorithm, select the link on which the segment is transmitted in order of the priorities.

3. The packet switch according to claim 2,
wherein the ingress unit further has a third algorithm including processes for selecting the link on which the back pressure signal is transferred and on which the segment have not been transmitted in the specific period, the priority of the third algorithm being set lower than the priority of the second algorithm.

4. The packet switch according to claim 3,
wherein each of the first to third algorithms further includes processes for selecting a link on which the segment is transmitted by a round robin scheme in which a link subsequent to the link on which the segment have been transmitted in the specific period is set as a highest priority link.

5. The packet switch according to claim 4,
wherein the ingress unit increments a value of the transmission flag for the link on which the segment have been transmitted by one when the segment have been transmitted, determines that the segment have been transmitted in the specific period when the value of the transmission flag is 1, and determines that the segment have not been transmitted in specific period when the value of the transmission flag is 0.

6. The packet switch according to claim 5,
wherein the ingress unit decrements the values of the transmission flags for all of the plurality of links by one when the values of the transmission flags for all of the plurality of links are 1 or more.

7. A transmission device comprising:
a packet switch including:
an ingress unit configured to divide packet data into a plurality of segments, and allocate each of the plurality of segments to any one of a plurality of links;
a switching fabric unit configured to include a plurality of switches, each of the plurality of switches switching the segments from the ingress unit to the plurality of links, respectively; and
an egress unit configured to receive the segments from the plurality of switches, reconstruct the received segments in the packet data, and transmit the reconstructed packet data,
wherein the ingress unit transmits the segments to the links on which no back pressure signal is transferred and another link on which the back pressure signal is transferred and on which the segment have not been transmitted in specific period, based on a back pressure signal supplied from each of the plurality of switches and a transmission flag indicating whether or not the segment have been transmitted to the plurality of links.

8. A packet transmission method comprising:
dividing packet data into a plurality of segments;
allocating each of the plurality of segments to any one of a plurality of links;
switching the allocated segment to the plurality of links in accordance with destinations of the segments, respectively; and
reconstructing the switched segments in the packet data,
wherein the allocated segment is transmitted to the links on which no back pressure signal is transferred and another link on which the back pressure signal is transferred and on which the segment have not been transmitted in specific period, based on the back pressure signal and a transmission flag indicating whether or not the segment have been transmitted to the plurality of links.

9. The packet transmission method according to claim 8,
wherein, in the allocating, the link on which the segment is transmitted is selected in order of priorities set to a first algorithm and a second algorithm, the first algorithm including processes for selecting a link on which no back pressure signal is transferred and on which the segment have not been transmitted in the specific period and causing the segment to be transmitted to the selected link, the second algorithm including processes for selecting another link on which no back pressure signal is transferred and on which the segment have been transmitted in the specific period and causing the segment to be transmitted, and the priority of the first algorithm being higher than the priority of the second algorithm.

10. The packet transmission method according to claim 9,
wherein, in the allocating, the link on which the segment is transmitted is selected in order of priorities set to the first algorithm, the second algorithm, and a third algorithm, the third algorithm including processes for selecting the link on which the back pressure signal is transferred and on which the segment have not been transmitted in the specific period, the priority of the third algorithm being set lower than the priority of the second algorithm.

11. The packet transmission method according to claim 10,
wherein each of the first to third algorithms further includes processes for selecting a link on which the segment is transmitted by a round robin scheme in which a link subsequent to the link on which the segment have been transmitted in the specific period is set as a highest priority link.

12. The packet transmission method according to claim 11,
wherein, the allocating further including:
increasing a value of the transmission flag for the link on which the segment have been transmitted by one when the segment have been transmitted;
determining that the segment have been transmitted in the specific period when the value of the transmission flag is 1; and
determining that the segment have not been transmitted in specific period when the value of the transmission flag is 0.

13. The packet transmission method according to claim 12,
wherein, the allocating further including:
decreasing the values of the transmission flags for all of the plurality of links by one when the values of the transmission flags for all of the plurality of links are 1 or more.
